(19) United States
(12) Patent Application Publication
(10) Pub. No.: US 2023/0400575 A1
(43) Pub. Date: Dec. 14, 2023

(54) ADDRESSING DETERMINATION METHOD AND APPARATUS, AND DEVICE AND STORAGE MEDIUM

(71) Applicant: SHENZHEN ADAPS PHOTONICS TECHNOLOGY CO., LTD., Shenzhen (CN)

(72) Inventors: Letian Wang, Shenzhen (CN); Chao Zhang, Shenzhen (CN); Kai Zang, Shenzhen (CN)

(21) Appl. No.: 18/456,279

(22) Filed: Aug. 25, 2023

Related U.S. Application Data
(63) Continuation of application No. PCT/CN2022/077791, filed on Feb. 25, 2022.

(30) Foreign Application Priority Data
Feb. 26, 2021 (CN) 202110216962.0

(51) Int. Cl. G01S 17/08; G01S 7/4865; G01S 7/497

(52) U.S. Cl. CPC G01S 17/08; G01S 7/4865; G01S 7/497

(57) ABSTRACT

The present invention relates to an addressing determination method. By obtaining the calibration position of the light reflected back from the target object detected by the detector at a specified distance, the first sensing distance of the target object within the first time interval, and the first sensing position of the detector, the invention combines an optical model to obtain the first predicted position of the detector at the specified distance based on the first sensing distance and the first sensing position. The invention further determines whether the first predicted position is the same as the calibration position. If the two positions are different, it indicates errors in the process of selecting the region of interest or obtaining the first sensing position within the region of interest.

### CROSS-REFERENCES TO RELATED APPLICATIONS

The present application is a continuation to PCT Application No. PCT/CN2022/077791, filed Feb. 25, 2022, entitled “ADDRESSING DETERMINATION METHOD AND APPARATUS, AND DEVICE AND STORAGE MEDIUM”, which claims priority to Chinese Patent Application No. 202110216962.0, filed Feb. 26, 2021, both of which are common owned and incorporated by reference herein for all purposes.

### FIELD OF INVENTION

The technical field of the present invention is LiDAR technology, specifically focusing on an addressing and determining method, device, apparatus, and storage medium.

### BACKGROUND OF THE INVENTION

Time of Flight (ToF) measurements, reliant on separate setups for the transmitter and receiver, provide a technological approach for determining the position of a target object. Notably, due to the parallax effect between the transmitter and receiver, variations in the distance between the transmitter and the target object result in the light beam—emanated by the transmitter and reflected by the target object—being cast onto differing positions on the receiver.

Typically, the transmitter's light emitter discharges light signals in a dispersed pattern. To manage these dispersed points, a prevalent technique involves estimating a broad sensing range (region of interest) at the receiver, taking into account the positions of the light emitters, the distance between the emitters and the target object, and familiarity with the optical system's architecture. Subsequently, only the detection units found within this sensing range are activated to register the light signals, with the precise positions of the dispersed points established based on the identified positions of the activated detection units.

However, potential errors may occur in defining the region of interest based on the understanding of the optical system structure, or in pinpointing the initial detected positions within that region, due to influences like ambient light, mechanical changes, and external forces. Consequently, mismatches might arise between the addressed positions and the actual positions of the dispersed points. Regrettably, these errors are often overlooked during the addressing process as users typically don't authenticate their existence.

### BRIEF SUMMARY OF THE INVENTION

Based on this, it is necessary to provide a method, apparatus, device, and storage medium capable of determining whether the scatter positions obtained according to the original mapping relationship are accurate.

An addressing and determining method comprises the following steps:
Obtaining the calibration position where the detector detects the reflected light signal from the target object at a specified distance;
Separately obtaining the first sensed distance of the target object and the first sensed position of the detector within the first time interval;
Utilizing an optical model to determine the first predicted position of the detector at the calibration distance, based on the first sensed distance and the first sensing position;
If it is determined that the first predicted position and the calibration position are different, executing a predefined strategy. The predefined strategy may involve adjusting the calibration position, outputting accidental error information, or updating the first predicted position.

In an embodiment, a method for executing the predefined strategy includes the following additional steps:
Separately obtaining the second sensed distance of the target object and the second sensed position of the detector within the second time interval;
If the first sensed distance is equal to the second sensed distance, and the first sensed position is the same as the second sensed position, then calculating an adjustment rate. Using the calculated adjustment rate, the calibration position, and the first predicted position, adjust the calibration position accordingly.

In another embodiment, a method for executing the predefined strategy includes the following additional steps:
If the first sensed distance is different from the second sensed distance, and the first sensed position is different from the second sensed position, then, based on the optical model, calculate the second predicted position of the detector at the calibration distance using the second sensed distance and position;
If the first predicted position and the second predicted position are the same, then calculate an adjustment rate. Using the calculated adjustment rate, the calibration position, and the first predicted position, adjust the calibration position accordingly.

In another embodiment, a method for executing the predefined strategy includes the following additional step:
If the first predicted position is different from the second predicted position, then output accidental error information.

In another embodiment, a method for executing the predefined strategy includes the following additional step:
If the first sensed distance is the same as the second sensed distance, but the first sensed position is different from the second sensed position, or if the first sensed distance is different from the second sensed distance, but the first sensed position is the same as the second sensed position, then update the first predicted position.

In a specific embodiment, the step of updating the first predicted position includes the following:
Re-obtaining the first sensed distance and the first sensed position;
Utilizing the optical model, update the first predicted position based on the re-obtained first sensed distance and first sensed position.

In a specific embodiment, the step of adjusting the calibration position based on the adjustment rate, calibration position, and first predicted position includes the following actions:
Calculate the difference between the calibration position and the first predicted position;
Determine the adjustment value by applying the adjustment rate to the calculated difference;
Calculate the adjusted calibration position by subtracting the adjustment value from the calibration position.

In an embodiment, a detector includes single-photon avalanche diodes (SPADs). An addressing and determining device is described, which comprises the following components:
Calibration position acquisition module: Used to obtain the calibration position where the detector detects the reflected light signal from the target object at a specified distance;
Distance acquisition module: Used to obtain the first sensed distance of the target object within the first time interval;
Sensing position acquisition module: Used to obtain the first sensed position of the detector within the first time interval;
Predicted position acquisition module: Based on the optical model, it calculates the first predicted position of the detector at the calibration distance using the first sensed distance and the first sensed position;
Determination module: If it is determined that the first predicted position and the calibration position are different, it executes predefined strategies. The predefined strategies may include adjusting the calibration position, outputting occasional error information, or updating the first predicted position.

An addressing and determining device comprises a memory and a processor. The memory stores a computer program, and the processor executes the computer program to implement the steps of any one of claims.

A computer-readable storage medium is provided, storing a computer program. When executed by a processor, the computer program implements the steps of any one of the above methods as described in claims.

The above addressing and determining method, device, equipment, and storage medium work by first obtaining the calibration position where the detector senses the reflected light signal from the target object at a specified distance. Then, it acquires the first sensed distance of the target object within the first time interval and the first sensed position of the detector within the same time interval. By applying an optical model, it calculates the first predicted position of the detector at the calibration distance using the first sensed distance and position. Next, the method determines whether the first predicted position matches the calibration position. If it is determined that the first predicted position and the calibration position are different, it indicates that errors may have occurred in the process of selecting the region of interest or obtaining the first sensed position within the region of interest. In such cases, the method provides several options for further action. It can adjust the calibration position to bring it closer to the first predicted position, or it can output occasional error information to alert the user about the discrepancy. Alternatively, the method may update the first predicted position to refine its accuracy.

### BRIEF DESCRIPTION OF THE DRAWINGS

To provide a clearer explanation of the technical solutions in the present application's embodiments or the prior art, a brief introduction to the figures used in the embodiments or prior art descriptions is presented below. It is evident that the figures described below are merely some embodiments of the present application. For ordinary skilled practitioners in the field, without expending creative efforts, they can obtain additional figures based on these figures.

FIG. 1 provides a simplified flowchart of an addressing determination method for an embodiment;

FIG. 2 provides a simplified flowchart of an addressing determination method for another embodiment;

FIG. 3 provides a simplified flowchart of an addressing determination method for yet another embodiment;

FIG. 4 provides a simplified flowchart of a step for adjusting the calibration position based on the adjustment rate, calibration position, and first predicted position for one embodiment;

FIG. 5 provides a simplified flowchart of an addressing determination method for another embodiment;

FIG. 6 is provides a simplified diagram of an embodiment where the scattered points are located on the detection unit.

### DETAILED DESCRIPTION OF THE INVENTION

In order to facilitate a comprehensive understanding of the present application, the following description will refer to the accompanying drawings to provide a more detailed explanation. The drawings present embodiments of the present application. However, it should be noted that the present application can be implemented in various forms and is not limited to the embodiments described herein. Instead, these embodiments are provided to enhance the disclosure of the present application.

Unless otherwise defined, all technical and scientific terms used in this document have the same meanings as commonly understood by those skilled in the art of the present application. The terms used in this specification are intended solely for the purpose of describing specific embodiments and not to limit the scope of the present application.

It should be understood that the terms “first,” “second,” and the like, may be used in this document to describe various elements, but these elements are not limited by such terms. These terms are used merely to distinguish one element from another. For example, without departing from the scope of the present application, the first sensing distance may be referred to as the second sensing distance, and vice versa. Both the first and second sensing distances are sensing distances, but they are not the same sensing distance.

It should be understood that the term “connection” in the following embodiments should be interpreted as “electrical connection” or “communication connection” if the connected circuits, modules, units, etc., transmit electrical signals or data to each other.

In this usage, the singular form of “one” and “a” and the terms “said/this” may also include the plural form unless context clearly indicates otherwise. Additionally, terms such as “comprising/including” or “having” specify the presence of the stated features, integrals, steps, operations, components, parts, or their combinations, but do not exclude the possibility of one or more other features, integrals, steps, operations, components, parts, or their combinations.

Furthermore, the term “and/or” used in this specification includes any and all combinations of the items listed in the related enumeration.”

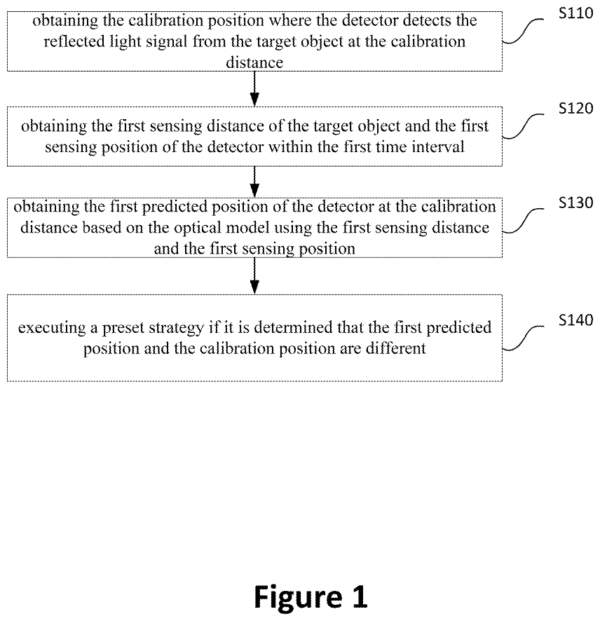

FIG. 1 provides a simplified flowchart of an addressing determination method for an embodiment. As shown in FIG. 1, the addressing determination method includes steps S110 to S140.

Step S110 involves obtaining the calibration position where the detector detects the reflected light signal from the target object at the calibration distance.

Specifically, the calibration distance is a predetermined distance value between the transmitting end and the target object. The transmitting end may comprise multiple light emitters, with each light emitter distributed in a scattered manner. The receiving end is equipped with detectors, wherein the detectors include multiple detection units (pixels). The light emitters emit light signals towards the target object, and after the light signals are reflected by the target object, they propagate to the receiving end. The calibration position refers to the position of the detector where the reflected light signal is detected at the calibration distance.

Step S120 involves separately obtaining the first sensing distance of the target object and the first sensing position of the detector within the first time interval. Specifically, at the starting time, which is the current moment, the first sensing distance of the target object is obtained. This first sensing distance is the distance value between the transmitting end and the target object. Simultaneously, based on the position of the light emitter that emits the light signal, and considering the optical system's structure, a region of interest is determined. Only the detection units within this region of interest are activated, and the coordinates of the detection unit that receives the light signal are obtained as the first sensing position.

The first time interval is the time period between the current moment and the time when the first sensing distance and first sensing position are obtained.

The first sensing distance of the target object can be calculated by obtaining the flight time of the light signal during the first time interval.

In an embodiment, the detector may include single-photon avalanche diodes (SPADs).

Step S130 involves obtaining the first predicted position of the detector at the calibration distance based on the optical model using the first sensing distance and the first sensing position.

Specifically, the optical model contains a pre-established mapping relationship between the sensing distance of the target object, the sensing position of the detector, and the predicted position of the detector at the calibration distance. Based on this optical model and using the first sensing distance and the first sensing position, the first predicted position of the detector can be obtained. In one embodiment, the optical model can be constructed based on sample calibration positions, sample sensing distances of the target object, and sample sensing positions of the detector.

It is important to note that the sensing position of the detector changes with the variation of the sensing distance of the target object. To determine whether the obtained sensing position of the detector corresponds to the actual reflection position of the light signal, after obtaining the first sensing distance of the target object and the first sensing position of the detector, the first sensing position at the first sensing distance can be transformed into the first predicted position at the calibration distance based on the optical model. Then, this predicted position can be compared with the calibration position at the calibration distance to determine if there is any deviation in the obtained first sensing position.

Step S140 involves executing a preset strategy if it is determined that the first predicted position and the calibration position are different. The preset strategy includes the following options: adjusting the calibration position, outputting accidental error information, or updating the first predicted position.

It is important to understand that ideally, the first predicted position would match the calibration position. If they are not the same, it indicates that there might be an error in at least one of the steps involving selecting the region of interest or obtaining the first sensing position within the region of interest, based on the understanding of the optical system. This error results in a deviation in the first predicted position from the true value represented by the calibration position. As a response to this discrepancy, the preset strategy can be executed to either alert about addressing errors, or improve the accuracy of the addressing process, or both.

In an embodiment, if it is determined that the first predicted position and the calibration position are different, the system can execute two or all three of the following actions: adjust the calibration position, output accidental error information, and update the first predicted position.

Note that after adjusting the calibration position, outputting occasional error information, or updating the first predicted position, the system continues to execute steps S110 to S140 to reevaluate the situation. This process repeats in a loop.

An embodiment of the invention involves obtaining the calibration position of the reflected light signal from a target object detected by a detector at a calibrated distance, the first sensing distance of the target object within the first time interval, and the first sensing position of the detector. Then, based on the optical model and using the first sensing distance and position, the first predicted position of the detector at the calibrated distance is determined. It is then checked whether this first predicted position matches the calibration position. If they do not match, it indicates errors in the selection process based on the region of interest or in obtaining the first sensing position within the region of interest. In such a case, the calibration position can be adjusted, or accidental error information can be outputted, or the first predicted position can be updated to validate the addressing process for the existence of deviations. Consequently, this method enables self-examination of the scatter addressing approach.

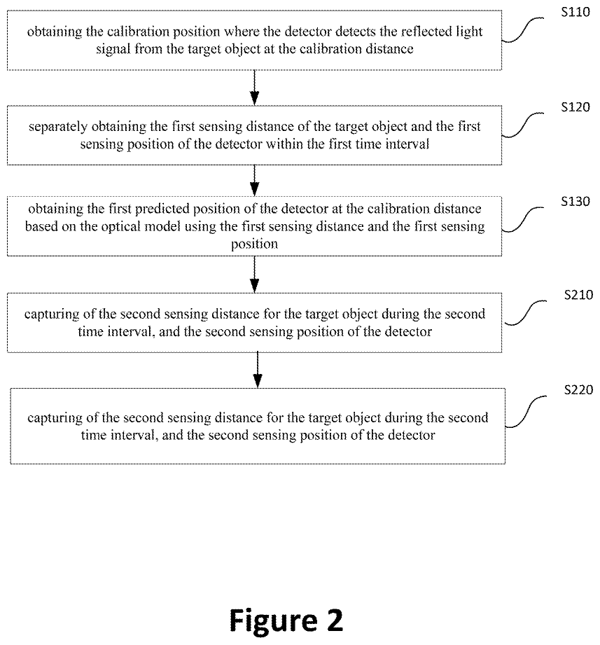

FIG. 2 provides a schematic representation of an addressing determination method for a subsequent embodiment. This version closely resembles the one outlined in FIG. 1, with its distinctiveness rooted in the application of predetermined steps, encompassing S210 through S230.

Step S210 involves obtaining the second sensing distance for the target object during the second time interval, and the second sensing position of the detector.

Under consistent parameters, the second sensing distance and position are captured within a time frame distinct from the first interval. This second span might align with an earlier phase in the addressing procedure. Post the acquisition of sensing distances and positions within every designated interval, these metrics are archived. As the first sensing distance and position undergo validation within the first interval, a previously logged interval can be adopted as the second. The metrics from this chosen interval serve as the second sensing distance and position, which are subsequently juxtaposed against the first set. The distances for each interval are derived by gauging the light signal's duration during that phase and meshing it with light's velocity. Position metrics for each interval hinge on the locus of the active light emitter during that span. Harnessing the optical system's layout to earmark the region of interest, and by activating only pertinent detection units, we can decipher the coordinates of the light-receptive unit, marking it as the sensing position.

For Step S220, when the first sensing distance matches the second sensing distance, and their sensing positions are the same, an adjustment rate is gotten. Utilizing this rate, the calibration position and the first predicted position, recalibrations are made to the calibration position. Furthermore, in instances where discrepancies emerge between the first predicted position and calibrated positions, it's feasible to analyze the second sensing distance (from the second interval) vis-a-vis the first (from the initial interval), and the same for their positions. A match between the first and second sensing distances and a congruence in positions hints at sustained disruptions during the addressing phase, potentially skewing the first predicted position. For example, the parallelism between the two sets of distances and positions can be deduced by computing their respective variances. Identical metrics indicate that the first pair of sensing distance and position matches the second pair. Persistent interferences, leading to such misalignments, might stem from mechanical oscillations, temperature flux, or compromised signal clarity. To counteract these variances, a predetermined adjustment rate can be integrated with the calibration and first predicted positions, yielding a revised calibration. In future addressing iterations, this newly calibrated position can be set against the projected position.

After making adjustments to the calibrated position, as a new preset time interval emerges, both the first sensing distance and position are freshly procured. These metrics aid in predicting the first predicted position. What follows is determining if the first predicted position is the same as the calibrated position. If they aren't the same, obtain the second sensing distance and the second sensing position. When the first and second distances are the same, and their respective positions are the same, an adjustment rate is established. Using this rate, the calibration is revised based on the current calibrated and predicted positions, forming a repetitive cycle. This iterative approach, facilitated by the adjustment rate, refines the calibrated position across multiple addressing rounds, offering enhanced precision over a singular, direct adjustment. The adjustment rate falls below 1, typically lying between 0.03 and 0.2. The lower threshold, 0.03, is influenced by frame rates and confidence levels, ensuring post-exposure movement of the calibrated position towards the first predicted position is significant. Conversely, the 0.2 cap relates to system specifications, preventing excessive shifts. Absent an adjustment rate, shifts would span merely a single detection unit's distance. However, with the rate, the adjustments are more nuanced, permitting simultaneous discernment and motion. This stops overreaches and staves off errors stemming from overcorrection.

In an embodiment, the design is further refined to counterbalance a less-than-optimal signal-to-noise ratio by modulating the optical signal's strength and pulse count. Within this particular manifestation of the invention, if the first predicted position deviates from the calibrated one, the second predicted distance and position (from the next time interval) are separately gathered. These figures are pitted against the initial sensing distance and position. If congruencies emerge, an adjustment rate is harnessed to tweak the calibrated position. Incorporating this extra phase effectively nullifies the ramifications of persistent disturbances, subsequently improving the accuracy of the addressing determination.

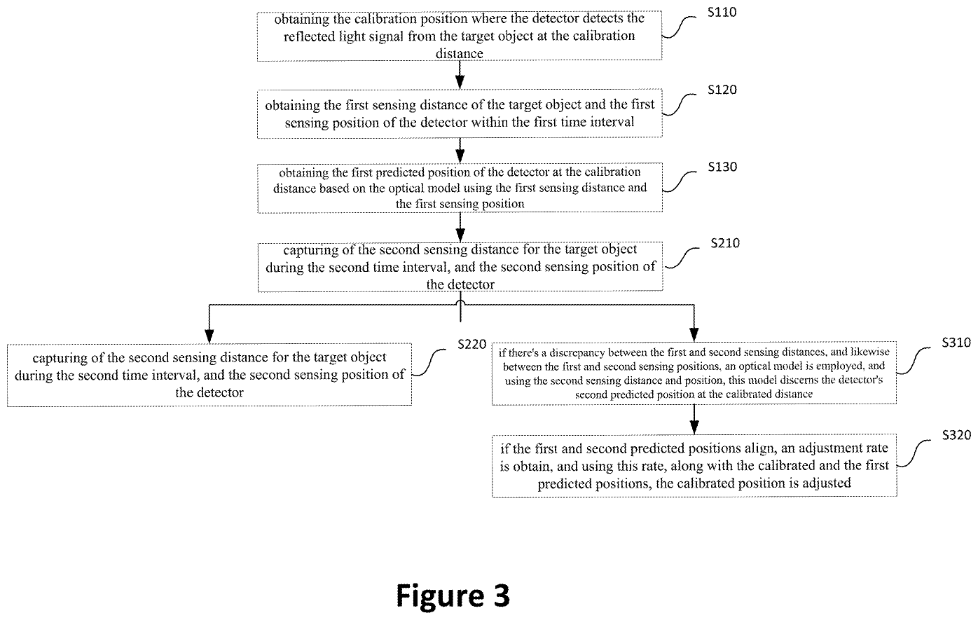

In FIG. 3 provides another embodiment of the addressing determination method. While it bears a resemblance to the method illustrated in FIG. 2, a distinct feature in this embodiment is the addition of steps S310 to S320 as part of its preset strategy.

Step S310, if there's a discrepancy between the first and second sensing distances, and likewise between the first and second sensing positions, an optical model is employed. Utilizing the second sensing distance and position, this model discerns the detector's second predicted position at the calibrated distance. Importantly, this optical model—which is used for both the first and second predicted positions based on their respective sensing distances and positions—remains consistent. This uniform application guarantees the second predicted position's precision.

Step S320, if the first and second predicted positions align, an adjustment rate is obtain, and using this rate, along with the calibrated and the first predicted positions, the calibrated position is adjusted. Understanding this step is crucial: if both predicted positions are identical, it hints at ongoing, constant interference during the addressing. This interference could skew the first predicted position, potentially stemming from mechanical oscillations, temperature variations, or an inadequate system signal-to-noise ratio. To combat such disturbances, a predetermined adjustment rate is employed, refining the calibrated position. This newly calibrated position can then be gauged against the predicted one in the succeeding addressing round.

An implementation provides that if a variance exists between the first and second predicted positions, the system flags this as an “accidental error”. For example, a discrepancy in both sets of sensed distances and positions—along with differing predicted positions—suggests fluctuation in target object sensing and light signal detection. Such inconsistencies point towards accidental errors in the addressing process, prompting the system to notify the user of these discrepancies.

In an embodiment, once the second sensing distance and position are obtained, the following steps ensue: if the first and second sensed distances match, but their positions diverge, or vice versa, the predicted position undergoes an update. This step acknowledges that if one set of measurements (either distances or positions) between the first and second sensing matches while the other differs, the initial predicted position should be reassessed and updated for enhanced accuracy.

In yet another embodiment, if the first and second sensing distances align, but their positions differ, and the updated first predicted position coincides with the calibrated one, it suggests the error isn't rooted in the target object's first sensing distance. Instead, issues may arise from the designated region of interest or other extreme circumstances. In such instances, the system might flag a region-of-interest selection error.

During the addressing procedure, the system pinpoints the region of interest and activates only the detection units within that region to capture the optical signal. Each of these units then quantifies the number of photon-trigger events using a time-to-digital converter, resulting in a tally that represents photon triggers for each unit. A specific threshold is established, and units with a trigger count surpassing this threshold are identified as those genuinely detecting the optical signal. In certain scenarios, if there's an error in determining the region of interest, the threshold magnitude can be modified to rectify addressing inaccuracies stemming from this misidentification.

In a specific embodiment, if a discrepancy exists between the first and second sensing distances, but their positions align, and post the update, if the first predicted position coincides with the calibrated position, it signals an error in the target object's first sensing distance. This could also point to other exceptional circumstances. Under such conditions, the system can relay distance error information.

In an example, if a distance error is detected, the threshold value can be adjusted to counteract addressing issues due to this error.

According to an implementation, the process of updating the first predicted position entails reacquiring both the first sensing distance and position. Subsequently, using the prevailing optical model, along with the freshly procured first sensing distance and position, the first predicted position is recalibrated. In simpler terms, the update of the first predicted position is achieved by obtaining new values for the sensed distance and position. Using these values with the established optical model, a revised first predicted position is generated, supplanting its predecessor.

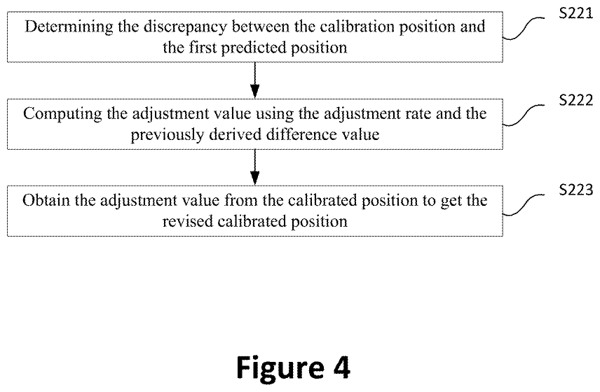

In a specific embodiment, as depicted in FIGS. 2 and 3, the recalibration of the calibration position considering the adjustment rate, calibration position, and the first predicted position encompasses steps S221 to S223, detailed in FIG. 4.

Step S221: Determine the discrepancy between the calibration position and the first predicted position.

This can be achieved by subtracting the first predicted position from the calibration position, yielding the difference value.

Step S222: Compute the adjustment value using the adjustment rate and the previously derived difference value.

More explicitly, once the difference value is identified, the adjustment value is ascertained by multiplying the adjustment rate with this difference value.

Step S223: Obtain the adjustment value from the calibrated position to get the revised calibrated position.

After procuring the adjustment value, subtraction between the calibrated position and this adjustment value gives the adjusted calibrated position. This can be represented by formula (1): Inew=I−α(I−I′) (1)

Where: Inew stands for the newly adjusted calibrated position, I represents the original calibrated position, I′ denotes the predicted position, and a symbolizes the adjustment rate.

It's worth noting that post calibration adjustments, the process revisits steps S110 to S140 iteratively until the first predicted position aligns with the calibrated position.

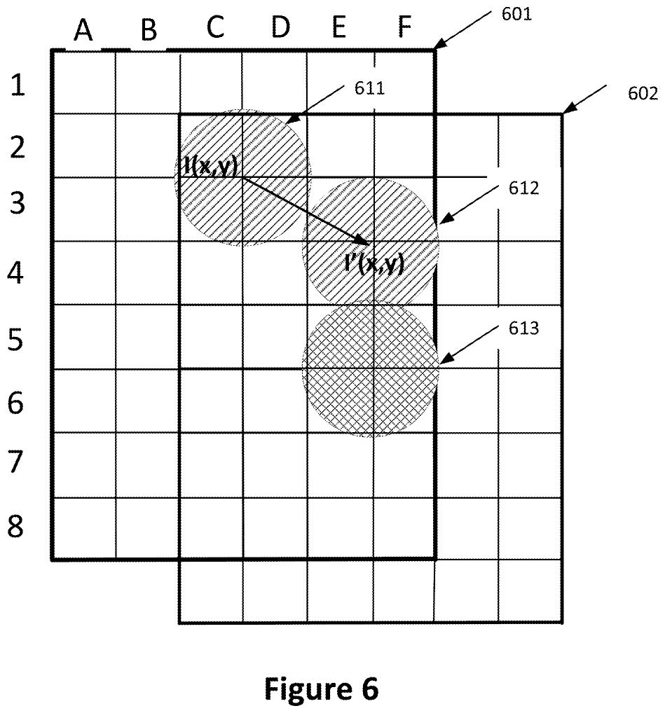

As illustrated in FIG. 6, point 611 is the original calibration position, 612 represents the first predicted position, while 613 denotes the first sensing position. These positions are characterized by the vector I(x, y). Here, I symbolizes the calibration position and I′ the first predicted position. Given that the calibration scatter points span four detection units, these units' positions can be identified as I(C, 2), I(C, 3), I(D, 2), and I(D, 3). In a similar manner, the points related to the first predicted position span four detection units, with their positions being I′(E, 3), I′(E, 4), I′(F, 3), and I′(F, 4). According to the formula (1), there's a requirement to shift the calibration position I multiple times until it aligns with the first predicted position I′, which then is adopted as the calibrated position.

The position of the calibration is instrumental in determining the sensing range. For instance, in FIG. 6, if the calibration position is located at I, the sensing domain is confined within the boundary depicted by 601. This ensures that all detection units encompassed by this boundary are activated, while the ones outside are rendered inactive. A shift in calibration to I′ places the sensing domain within the boundaries illustrated by 602, thus activating the corresponding detection units and deactivating the rest. These active units are essential as they have the capability to intercept photon signals vital for gauging distance.

However, factors like temperature variations or mechanical modifications can potentially misplace the calibration position, subsequently causing a mismatch in the true positions of the detection units designated for measurement. Without the necessary recalibration, the detection units originally in the sensing domain may falter in effectively capturing photon signals. In FIG. 6, if the calibration remains steadfast at position 611 and there's a shift in distance to the target object, the scatter point positions are expected to navigate vertically within columns C and D, conforming to the optical model. Contrarily, the genuine first sensing position of the target object is situated at 613. Delving into the optical model, the optimal calibration placement should be 612. This mandates a shift from the calibration position at 611 to 612, while concurrently adjusting the sensing domain from 601 to 602. This realignment is imperative because, during detection, any variation in the distance to the target object requires the point positions to shift vertically within columns E and F, adhering to the optical model. Such discrepancies can disrupt the compilation of histogram data, leading to error distance measurements.

According to existing approaches, calibration was a task entrusted solely to the manufacturers. However, if unforeseen factors such as thermal changes or mechanical tweaks displace the calibration, end-users were rendered powerless to recalibrate during its application, paving the way for inaccuracies. This innovative approach empowers users to attain self-calibration even without active involvement in the calibration procedure. The system tactically harnesses the first sensed position, acquired during the ranging system's operation, for retrospective computations. Through a comparative analysis to discern potential offsets in the calibration position and to establish the consistency of these offsets, the calibration steps are initiated if these offsets remain constant. This application liberates users from over-relying on factory settings, allowing for self-calibration and ensuring the precision of distance measurements.

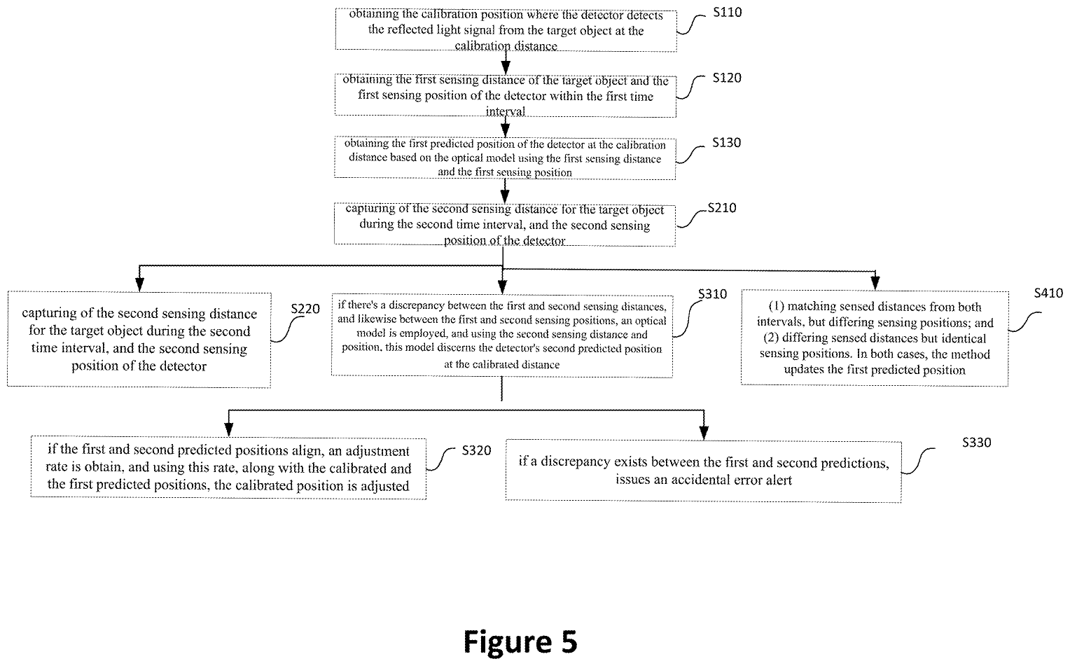

FIG. 5 provides a flowchart illustrating another embodiment of the addressing determination method. This method includes the following:

Step S110, the method identifies the calibrated position where the detector captures the reflected light signal from the target object at a specified calibrated distance.

Step S120 involves determining the first sensing distance to the target object and the detector's first sensing position within the first time frame.

Step S130, using the optical model, the first sensing distance and the first sensing position, the method calculates the detector's first predicted position at the calibrated distance. IF there is a discerned variance between this first predicted position and the calibrated one, the process advances to Step S210.

Step S210, acquiring the second sensing distance to the target object and the detector's second sensing position within a subsequent time interval. Following this, it assesses the relationship between the first and second sensing distances and the first and second sensing positions. Output from this assessment direct the process to either Step S220, S310, or S410.

Step S220 When both the sensing distances and sensing positions from the two intervals match, obtain an adjustment rate. Utilizing this rate, along with the calibrated and first predicted positions, the method fine-tunes the calibrated position.

Step S310, If there are disparities between the first and second sensing distances, and between the first and second sensing positions. Drawing from the optical model and considering the second sensing distance and position, the method calculates a second predicted position for the detector at the calibrated distance.

Step S410 addresses two specific scenario: (1) matching sensing distances from both intervals, but differing sensing positions; and (2) differing sensing distances but identical sensing positions. In both cases, the method updates the first predicted position.

Upon completing Step S310, the process branches to Steps S320 and S330. Step S320 if the first and second predicted positions are the same, using the adjustment rate, recalibrates the initial position. Step S330, In contrast, if a discrepancy exists between the first and second predicted positions, issues an accidental error alert. Notably, Steps S220 and S320 might incorporate Steps S221 to S223, as highlighted in the embodiment portrayed in FIG. 4.

In addition to the method, this invention embodiment introduces an addressing determination apparatus consisting of several modules.

The calibration position acquisition module, is used to fetch the calibrated position where the detector receives the reflected light signal from the target object at the calibrated distance.

The distance acquisition module is tasked with determining the target object's first sensing distance within the first time span.

The sensing position acquisition module, is used to obtain the first sensing position of the detector within the first time span.

The prediction position acquisition module, relying on the optical model and the first sensing distance and position, is used to obtain the first predicted position of the detector at the calibrated distance.

The determination module, is used to execute predefined strategy when a mismatch is detected between the first predicted and calibrated positions. Based on a predefined strategy, this module either adjusts the calibrated position, emits an accidental error notification, or revises the first predicted position.

In a specific embodiment, the distance acquisition module not only acquires the first sensing distance but also fetches the second sensing distance of the target object within a second time spad. Similarly, the sensing position acquisition module acquires both the primary and secondary sensing positions of the detector in their respective time spad. The task of the determination module is to ascertain the difference between the first and second sensed distances, as well as between the first and second sensing positions. When there is alignment in both sensing distances and sensing positions, the addressing determination device may incorporate an additional adjustment rate acquisition module and adjustment module. Adjustment rate acquisition module retrieves the adjustment rate, paving the way for another module—the adjustment module—to recalibrate the first position using the adjustment rate and the first predicted position.

Expanding on this, after securing the second sensing data, if discrepancies are identified between the first and second sensing distances and positions, the predicted position acquisition module comes into play. Drawing on the optical model, it calculates a second predicted position for the detector at the calibrated distance. Furthermore, the determination module also evaluates the alignment between the first and second predicted positions. If these predictions coincide, the adjustment process is reiterated with the adjustment rate acquisition module fetching the rate, followed by the adjustment module recalibrating the position.

In certain scenarios, the determination module may issue an accidental error alert, specifically when it identifies disparities between the first and second predicted positions. Moreover, this module can also trigger updates to the first predicted position under distinct circumstances: when either the sensing distances align but the sensing positions differ or vice versa.

Regarding the process of updating the first predicted position, it involves revisiting the first sensing data. The optical model is then leveraged to refresh the first predicted position using the newly acquired data. If the module discerns aligned sensing distances but varied sensing positions and calls for an update to the first predicted position, it undertakes a further evaluation. It verifies if this updated prediction matches the calibrated position. If it does, the module transmits an error message pertinent to the region of interest (ROI error).

Alternatively, when the sensing distances are found to be distinct, but the sensing positions match, the determination module revisits the first predicted position. Upon this update, if the recalculated position is in sync with the calibrated position, a distance error alert is dispatched by the module.

The adjustment module measures the discrepancy between the calibrated and first predicted positions. It computes an adjustment value derived from the adjustment rate and the observed difference. The final calibrated position is then deduced by juxtaposing the original calibrated position with this adjustment value.

To encapsulate the invention's technical facets, an embodiment offers an addressing determination apparatus equipped with a memory and a processing unit. The memory houses a computer program, and when this program runs on the processor, it orchestrates the sequences delineated across the aforementioned embodiments.

The present invention, in various embodiments, may involve a computer-readable storage medium in one of its embodiments. This medium contains a computer program, and when executed by a processor, it facilitates the realization of the steps outlined in the previously described methods and embodiments.

Throughout this document, phrases like “some embodiments,” “other embodiments,” “preferred embodiments,” and so on, are utilized to point towards particular features, structures, materials, or characteristics that accompany the described embodiments or examples. It's imperative to understand that these terms might not always pertain to identical embodiments or examples, even though these specifics might be inherent in one or more embodiments of the current invention.

Various technical attributes in the discussed embodiments can be freely combined. For brevity's sake, not every potential combination of these attributes is elaborated upon in this document. Yet, any combination that doesn't present contradictions should be deemed to fall within the purview of this description.

The embodiments detailed here are merely illustrative of several ways to manifest the present invention. Despite the specificity of these descriptions, they shouldn't be viewed as restrictive confines for the invention. It's worth noting that professionals in this domain could devise numerous adjustments and enhancements while adhering to the invention's core principles. All such alterations and augmentations are encompassed within the boundaries of the current invention. Hence, the extent of the invention's protection is determined by the accompanying claims.

What is claimed is:

1. An apparatus comprising:
a transmitting end comprising a first emitter, the transmitting end being positioned at a first location, the first emitter being configured to generate a first light signal at a first time and to generate a second light signal at a second time;
a receiving end comprising light detectors, the receiving end being positioned at a second location, the light detectors being configured to receive a first reflected signal at a third time and to receive a second reflected signal at a fourth time, the first reflected signal being associated with the first light signal, the second reflected signal being associated with the second light signal; and
a processor being configured to:
calculate a first distance using at least a difference between the first time and the third time;
identify a first detector position for detecting the first reflected signal using at least the first distance;
determine a predicted detector position using the first detector position and a difference between the first location and the second location;
calculate a second distance using at least a difference between the second time and the fourth time;
identify a second detector position for detecting the second reflected signal; and compare the predicted detector position against the second detector position.

2. The apparatus of claim 1, the first light emitter comprises a laser diode.

3. The apparatus of claim 1, wherein the transmitting end further comprises a second light emitter.

4. The apparatus of claim 1, wherein the light detectors comprise single-photon avalanche diodes (SPADs).

5. A method comprising:
transmitting a first light signal from a first location at a first time;
receiving a first reflected light signal at a second location at a second time;
calculating a first distance using at least a difference between the first time and the second time;
identifying a first detector position for detecting the first reflected signal using at least the first distance;
determining a predicted detector position using the first detector position and a difference between the first location and the second location;
transmitting a second light signal at a third time;
receiving a second reflected light signal at a fourth time;
calculating a second distance using at least a difference between the third time and the fourth time;
identifying a second detector position for detecting the second reflected signal using at least the second distance; and
comparing the predicted detector position and the second detector position.

6. The method of claim 5, wherein the first reflected light signal is from a target object at a known distance.

7. The method of claim 5, wherein a difference between the first time and the third time is based on a predetermined adjustment rate.

8. The method of claim 5, further comprising generating an alert based on a difference between the predicted detector position and the second detector position.

9. The method of claim 5, wherein the first detector position is associated with a plurality of single phone avalanche diodes (SPADs).

10. The method of claim 5, further comprising updating the predicted detector position using at least the first distance and the second distance.

11. The method of claim 5, further comprising calculating a calibration position using least the first detector position and the second detector position.

12. The method of claim 5, wherein the first detector position is associated with a first plurality of SPADs, and the second detector position is associated with a second plurality of SPADs.

13. A method comprising:
transmitting a first light signal from a first location at a first time;
receiving a first reflected light signal at a second location at a second time;
calculating a first distance using at least a difference between the first time and the second time;
identifying a first detector position for detecting the first reflected signal using at least the first distance;
determining a predicted detector position using the first detector position and a difference between the first location and the second location;
transmitting a second light signal at a third time;
receiving a second reflected light signal at a fourth time;
calculating a second distance using at least a difference between the third time and the fourth time;
identifying a second detector position for detecting the second reflected signal using at least the second distance; and
determining a calibration value using at least the predicted detector position and the second detector position.

14. The method of claim 13, further comprising providing an optical model based at least on a difference between the first location and a second location.

15. The method of claim 13, further comprising updating the predicted detector position based on a difference between the predicted detector position and the second detector position.

16. The method of claim 13, further comprising updating the predicted detector position based on a difference between the first distance and the second distance.
